(19) United States
(12) Patent Application Publication
(10) Pub. No.: US 2002/0040070 A1
(43) Pub. Date: Apr. 4, 2002

(54) POLYOL-BLOWING AGENT COMPOSITIONS WITH IMPROVED STORAGE STABILITY

(76) Inventors: MARY CHARLOTTE BOGDAN, WEST SENECA, NY (US); DENNIS PAUL KONOPA, EVANS, NY (US); DAVID JOHN WILLIAMS, WEST AMHERST, NY (US); ROBERT CHRISTIAN PARKER, HAMBURG, NY (US)

Correspondence Address: JAY P FRIEDENSON, ALLIEDSIGNAL INC LAW DEPARTMENT, P O BOX 2245, MORRISTOWN, NJ, 07962

(21) Appl. No.: 08/903,254

(22) Filed: Jul. 25, 1997

Related U.S. Application Data
(63) Continuation of application No. 08/533,028, filed on Sep. 25, 1995, now abandoned.

(51) Int. Cl. C09K 3/00; C08J 9/04

(52) U.S. Cl. 521/131; 252/182.24; 252/182.26; 252/182.27; 252/182.28

(57) ABSTRACT

Premixes of a polyol suitable for polyurethane or polyisocyanurate foam preparation and 1,1,1,3,3-pentafluoropropane require no stabilizer to inhibit reaction between the fluorocarbon and the polyol. These premixes are useful for polyurethane and polyisocyanurate foam preparation.

### FIELD OF THE INVENTION

This invention relates to improved polyurethane and polyisocyanurate foam systems which eliminate the need for stabilizers used in the past with certain fluorocarbon blowing agents. The improvement stems from the discovery that use of 1,1,1,3,3-pentafluoropentane (CF₃CH₂CHF₂) as the blowing agent provides enhanced chemical stability when the blowing agent is stored as a pre-mix, i.e. blowing agent, pre-blended with certain other components used in polyurethane-type foam manufacture, such as polyols.

### BACKGROUND OF THE INVENTION

It is well known to those skilled in the art that polyurethane and polyisocyanurate foams can be prepared by reacting and foaming a mixture of ingredients, consisting in general of an organic polyisocyanate (including diisocyanate) and an appropriate amount of polyol or mixture of polyols in the presence of a volatile liquid blowing agent, which is caused to vaporize by the heat liberated during the reaction of isocyanate and polyol. It is also well known that this reaction and foaming process can be enhanced through use of amine and/or tin catalysts as well as surfactants. The catalysts ensure adequate curing of the foam while the surfactants regulate and control cell size.

In the class of foams known as low density rigid polyurethane or polyisocyanurate foam the blowing agent of choice has been trichlorofluoromethane, CCl₃F, also known as CFC-11. These types of foams are closed-cell foams in which the CFC-11 vapor is encapsulated or trapped in the matrix of closed cells. They offer excellent thermal insulation, due in part to the very low thermal conductivity of CFC-11 vapor, and are used widely in insulation applications, e.g., roofing systems, building panels, refrigerators and freezers. Generally, 1-40 and typically, 15-40 parts of blowing agent per 100 parts polyol are used in rigid polyurethane or polyisocyanurate formulations.

Flexible polyurethane foams on the other hand are generally open-cell foams and are manufactured using a diisocyanate and polyol along with catalysts and other additives with various combinations of water, methylene chloride and CFC-11 as the blowing agent. These foams are widely used as cushioning materials in items such as furniture, bedding and automobile seats. The quantity of CFC-11 used as an auxiliary blowing agent in flexible foam manufacture varies from 1-30 parts by weight per 100 parts of polyol according to the grade of foam being prepared.

It is common practice in the urethane foam systems area to prepare so-called pre-mixes of certain components used to prepare the foam, i.e. often the appropriate quantities of polyol, blowing agent, surfactant, catalyst, flame retardant and other additives, are blended together and sold along with the stoichiometric quantity of polyisocyanate component in two separate containers. This is convenient for the end user who then only has to combine the two reactants in order to create a foam. It is also common practice for large foam manufacturing plants to pre-mix the polyol with the blowing agent in bulk storage containers. This liquid mixture possesses a lower viscosity than the pure polyol and is therefore easier to pump and meter into the mixing zone of the foam manufacturing equipment.

Special precautions must be taken when following these practices if the blowing agent is CFC-11, namely, the CFC-11 must have a stabilizer added to it in order to inhibit a reaction which can occur between the fluorocarbon and the polyol resulting in the production of acids such as hydrogen chloride and other organic products such as aldehydes and ketones. These reaction products have a detrimental effect on the reactivity characteristics of the foam ingredients which in the worst case results in no foaming action at all. Stabilizers found useful in stopping the reaction between fluorocarbon and polyol have been disclosed, for example, in U.S. Pat. Nos. 3,183,192 and 3,351,789. Use of such stabilizers with CFC-11/polyol based blends. although successful when measured in terms of fluorocarbon stability, have disadvantages such as added expense and sometimes cause odor problems which persist even in the finished foam.

For the above reasons, it would be advantageous to identify useful fluorocarbon blowing agents which do not require stabilizers in the presence of polyols. Unfortunately, there does not appear to be any reliable scientific basis upon which to predict such stability.

The propensity for a fluorocarbon species to react with an OH containing species, like a polyol, is dependent, in the fundamental sense, on the electronic and molecular structures of the fluorocarbon and the OH species involved. Studies of certain reactant systems, such as CFC-11 and ethanol by P. H. Witjens, Aerosol Age Vol. 4. No. 12 (December 1959), P. A. Sanders “Mechanisms of the Reaction Between Trichlorofluoromethane and Ethyl Alcohol”, Proc. of the CSMA 46th Mid-Year Meeting (May 1960), and J. M. Church and J. H. Mayer, J. Of Chem. And Eng. Data, Vol. 6 No. 3 (July 1961), have shown that the reaction products include hydrochloric acid acetaldehyde CHCl₂F. Sanders, in Soap and Chemical Specialties, (December 1965) has shown that these reactions are further promoted by the presence of metal and water.

H. M. Parmelee and R. C. Downing in Soap Sanitary Chemicals, Vol. 26, pp 114-119 (July 1950) have shown that fluorocarbons such as chlorodifluoromethane (FC-22), 1,1-Difluoroethane (FC-152a), 1,1,1-Chlorodifluoroethane (FC-142b) and 1,1,2,2-tetrafluoro-1,2-dichloroethane (FC-114) undergo reactions in aqueous and ethanol and isopropanol solutions in the presence of steel and aluminum.

To address the aforementioned need, fluorocarbon blowing agents were developed that did not require the use of a stabilizer. The developments were directed to the use of a hydrochlorofluorocarbons that did not require a stabilizer in the presence of polyols such as CFC-141b, as disclosed in U.S. Pat. No. 4,986,930, and CFC-123, as disclosed in U.S. Pat. No. 4,076,644.

In recent years, however, it has been determined that certain types of fluorocarbons released in the atmosphere adversely affect the stratospheric ozone layer By international agreement, it will soon become necessary to control the use and production of certain chlorofluorocarbons (CFCs) and hydrochlorofluorocarbons (HCFCs)

Therefore, there exists a need for alternative materials, to replace CFCs and HCFCs, which have lower ozone depletion potential while still achieving acceptable performance requirements. Hydrofluorocarbon (MC) compositions may be suitable as such alternative materials since HFCs do not contain chlorine, which is believed to be responsible for CFC's ozone depleting effect.

It is accordingly an object of this invention to identify a fluorocarbon useful as a blowing agent for polyurethane and polyisocyanurate foams which is stable in the presence of polyols, and is also considered to be a stratospherically safe substitute for CFCs and HCFCs (e.g., CFC-11, CFC-123 and CFC-141b) which are believed to be contributors to ozone depletion and global greenhouse warming.

Other objects and advantages of the invention will be apparent from the following description.

### SUMMARY OF THE INVENTION

The objects of the invention have been found to be achieved by using 1,1,1,3,3-pentafluoropropane (HFC-245fa) as the blowing agent.

Thus, the invention comprises premixes and mixtures of a polyol suitable for polyurethane or polyisocyanurate foam preparation and 1,1,1,3,3-pentafluoropropane in proportions suitable for polyurethane or polyisocyanurate foam preparation.

### DETAILED DESCRIPTION OF THE INVENTION

HFC-245fa is a known material and can be prepared by methods known to the art,

In accordance with the invention, HFC-245fa may be used as described in the background portion of this description to prepare a variety of polyurethane and polyisocyanurate foams by standard techniques known to the art which may include the use of various standard additives such as catalysts, surfactants, water and other materials.

The amount of HFC-245fa relative to the amount of polyol employed will vary depending upon the application, the type of foam being prepared, the identity of the polyol and other factors, and can readily be determined by anyone skilled in the art. Generally, from about 1 to 60 parts by weight of HFC-245fa per 100 parts by weight of polyol are employed, but preferably about 15 to 55 parts by weight of HFC-245fa per 100 parts by weight of polyol are used in rigid foam manufacture and about 1-30 parts by weight of HFC-245fa per 100 parts by weight of polyol are used in flexible foam manufacture.

Any suitable polyol, as would be apparent to those of skill in the art, may be used in the present invention. Examples of suitable polyols that may be used in the present invention include, but are not limited to, the following: polyethers, polyesters, methyl glucoside-based, reactive brominated diols, and mixtures and/or blends thereof Mention may be made, without limitation, of suitable polyether polyols, further described as follows, including, sucrose-based polyether polyols such as PLURACOL® 975 (from BASF Corp.), VORANOL® 370 and VORANOL® 490 (from Dow Chemical Co.) and THANOL® R-575 (from Eastman Chemical Co.); aromatic initiator-based polyether polyols such as PLURACOL® 824 (from BASF Corp.); aromatic amine-based polyether polyols such as THANOL® R-350-X, THANOL® R-450-X and THANOL® R-575 (from Eastman Chemical Co.); sucrose-amine based polyether polyols such as POLY-G® 71-357 (from Olin Corporation); amine-based polyether polyols such as NIAX® LA-700 (from ARCO Chemical Co.) and VORANOL® 800 (from Dow Chemical Co.); polyester polyols including aromatic-based polyester polyols such as TERATE® 203 (from Hoechst Celanese) and STEPANPOL ® PS-2502-A (from Stepan Company) and TEROL ® 256 (from Oxid, Inc.); amine-based triols such as SF-256 (from Eastman Chemical Co.); methyl glucoside-based polyols such as POLY-G® 75-442 (from Olin Corporation); and reactive brominated diols such as PHT4-DIOL (from Great Lakes Chemical Corporation).

| | | Viscosity | Water | | |
|---|---|---|---|---|---|
| | OH | 25° C. | Content | Density | Flash |
| Polyol | Number | (cp) | (%) | (lb./gal.) | Point† |
| PLURACOL ® 975 | 400 | 4,500 | 0.05 Max | 9.08 | >200° F. |
| | | | | @ 25° C. | |
| PLURACOL ® 824 | 390 | 10,500 | 0.05 Max | 9.09 | 200° F. |
| | | | | @ 25° C. | |
| TERATE ® 203 | 316 | 20,585 | Not | 1.2 | 156° F. |
| | | | Detected | (typ)* | |
| STEPANPOL ® | 230-250 | 2,000- | 0.15 Max | 10.0 | 200° F. |
| PS-2502A | | 4,000 | | @ 25° C. | |
| THANOL ® | 520-540 | 12,000- | 0.1 Max | 1.12 | 300° F. |
| R-350-X | | 17,000 | | @ 25° C.* | |
| THANOL ® 650-X | 440-460 | 22,000 | 0.10 | 1.06 | 305° F. |
| | | | | @ 20° C.* | |
| POLY-G ® 71-357 | 350 | 2,500 | 0.08 Max | 9.2 | 356° F. |
| | | | | @ 25° C. | |
| POLY-G ® 75-442 | 440 | 5,000 | 0.05 | 9.2 | 204° C. |
| | | | | @ 25 DC | |
| NIAX ® LA-700 | 700 | 100,000 | 0.1 Max | 1.05 | 455° F. |
| | | | | @ 20° C.* | |
| PHT4-DIOL | 220-235 | 90,000 | 0.1 (typ) | 1.8 | 200° F. |
| | | | | @ 25° C.** | |
| VORANOL ® 370 | 370 | 23,000 | 0.1 Max | 1.11 | 335° F. |
| | | | | @ 25° C.* | |
| VORANOL ® 800 | 800 | 17,300 | 0.10 | 8.75 | 405° F. |
| | | | | @ 25° C. | |
| †Flash points reported were determined using the following flash point methods: Pensky-Marten Cup test for the PLURACOL ® polyols; Cleveland Open Cup for the TERATE ®, POLY-G ® and NIAX ® polyols; SETA Flash Closed Cup for the | | | | | |
| STEPANPOL ® polyol; TAG Closed Cup for the PHT4 diol; and Pensky-Marten | | | | | |
| # Closed Cup for the THANOL ® and VORANOL ® polyols. | | | | | |

*indicates specific gravity
**indicates density (g/ml)

This invention is further illustrated by the following examples in which parts or percentages are by weight unless otherwise specified.

### EXAMPLE 1

In this example the stability of a pre-mix formulated with HFC-245fa is compared to a known storage-stable pre-mix formulated with HCFC-141b. The pre-mixes simulate commercial rigid polyurethane-type foam systems, and contain an equal number of moles of the respective blowing agents, taking into account the difference in their molecular weights.

The comparison is performed by measuring the apparent pH of the respective pre-mixes initially and after they had been aged for 15 weeks at 70° F. Since the fluorocarbon/polyol reaction will generally result in formation of acid, significant changes in apparent pH are stability-indicating. The apparent pH of each pre-mix was determined by direct measurement using a pH probe designed for use with high viscosity fluids. This type of measurement is believed to be accurate to plus or minus 0.1 pH units. The pre-mixes tested and the results are summarized in Table 1 which shows only very small and equivalent pH changes for the two systems.

TABLE 1
PRE-MIX APPARENT pH
STORAGE AT 70° F.

| | | pH | pH |
|---|---|---|---|
| Formulation | Parts by weight | Initial | 15 Weeks |
| PHT4 DIOL^{a} | 50 | | |
| THANOL ® R-575^{b} | 50 | | |
| DC-193^{c} | 1.5 | | |
| POLYCAT 8^{d} | 1.8 | | |
| N-95^{e} | 10 | | |
| HCFC-141b | 28 | 9.5 | 9.4 |
| HFC-245fa | 32 | 9.8 | 9.5 |

^{a}Polyol from Great Lakes Chemical
^{b}Polyol from Eastman Chemical
^{c}Surfactant (silicon glycol co-polymer) from Air Products and Chemicals
^{d}Amine Catalyst from Air Products
³Non-Ionic Surface Active Agent from Texaco Chemical Co.

### EXAMPLE 2

In this example the stability of a pre-mix formulated with HFC-245fa is compared to another pre-mix of known stability formulated with HCFC-141b. Again, apparent pH is used as an indicator of stability. The formulation and results are summarized in Table 2 which shows the two pre-mixes to be of equivalent stability.

TABLE 2
PRE-MIX APPARENT pH
STORAGE AT 70° F.

| | | pH | pH |
|---|---|---|---|
| Formulation | Parts by weight | Initial | 15 Weeks |
| PHT4 Diol | 40 | | |
| VORANOL ® 490^{a} | 30 | | |
| TEROL ® 245^{b} | 30 | | |
| DC-193 | 1.5 | | |
| POLYCAT 8 | 0.8 | | |
| N-95 | 10 | | |
| HCFC-141b | 27 | 8.9 | 9.0 |
| HFC-245fa | 32 | 9.1 | 9.0 |

^{a}Polyol from Dow Chemical Co.
^{b}Polyol from Oxid, Inc.

### EXAMPLE 3

In this example, the stability of a pre-mix formulated with HFC-245fa is again compared to a formulation of known stability containing HCFC-141b as described in Examples 1 and 2. In this case, however, the samples were stored for one month at the higher temperature of 130° F. to accelerate any potential reactions. The results shown in Table 3 demonstrate that the respective pre-mixes are of comparable stability.

TABLE 3
PRE-MIX APPARENT pH
STORAGE AT 70° F.

| | | pH | pH |
|---|---|---|---|
| Formulation | Parts by weight | Initial | 15 Weeks |
| THANOL ® R-470X^{a} | 67.76 | | |
| TERATE ® 203^{b} | 20.01 | | |
| SF-265^{a} | 7.66 | | |
| Glycerine | 4.57 | | |
| LK-443^{c} | 1.00 | | |
| Dabco R-8020^{d} | 1.80 | | |
| LEAD NAP-ALL 24%^{e} | 0.10 | | |
| FYROL PCF^{f} | 12 | | |
| HCFC-141b | 32 | 9.7 | 8.8 |
| HFC-245fa | 35 | 9.4 | 8.9 |

^{a}Polyol from Eastman Chemical
^{b}Polyol from Hoechst Celanese
^{c}Surfactant (organic, non-silicon) from Air Products and Chemicals
^{d}Catalyst (blended amine) from Air Products and Chemicals
^{e}Catalyst from Mooney Chemicals, Inc.
^{f}Additive (chlorinated phosphate ester) from Akzo Chemicals, Inc.

The data in Tables 1, 2 and 3 show that pre-mixes formulated with HFC-245fa and a variety of commonly used polyols are storage stable. This is both a useful feature, and one which could not be predicted or anticipated based upon the chemical structure or other properties of the compounds, as discussed in the background section of this description.

What is claimed is:

1. Premixes comprising east one polyol suitable for polyurethane or polyisocyanurate foam preparation and 1,1,1,3,3-pentafluoropropane in proportions suitable for polyurethane or polyisocyanurate foam preparation.

2. Premixes according to claim 1 containing about 1 to about 60 parts by weight per 100 parts by weight polyol of 1,1,1,3,3-pentafluoropropane.

3. Premixes according to claim 1 wherein said at least one polyol is selected from the group consisting of polyether polyols, polyester polyols, methyl glucoside-based polyols, reactive brominated diol polyols, and mixtures and/or blends thereof.

4. Premixes according to claim 1 wherein said at least one polyol is a polyether polyol.

5. Premixes according to, claim 1 wherein said at least one polyol is a polyester polyol.

6. Premixes according to claim 1 wherein said at least one polyol is a methyl glucoside-based polyol.

7. Premixes according to claim 1 wherein said at least one polyol is a reactive brominated diol.

8. Premixes according to claim 4 wherein said polyether polyol is a sucrose based polyether polyol.

9. Premixes according to claim 4 wherein said polyether polyol is a sucrose amine-based polyether polyol.

10. Premixes according to claim 4 wherein said polyether polyol is an aromatic amine-based polyether polyol.

11. Premixes according to claim 4 wherein said polyether polyol is an aromatic initiator-based polyether polyol.

12. Premixes according claim 4 wherein said polyether polyol is an amine-based polyether polyol.

13. Premixes according to claim 5 wherein said polyester polyol is an aromatic-based polyester polyol.

14. Premixes according to claim 4 wherein said polyester polyol is an amine-based triol.

15. The premixes of claim 8 wherein said polyol is PLURACOLO® 975.

16. The premixes of claim 8 herein said polyol is VORANOL® 370.

17. The premixes of claim 8 wherein said polyol is VORANOL® 490.

18. The premixes of claim 9 wherein said polyol is POLY-G® 71-357.

19. The premixes of claim 10 wherein said polyol is THANOL® R-350-X.

20. The premixes of claim 10 wherein said polyol is THANOL® R-450-X.

21. The premixes of claim 10 wherein said polyol is THANOL® 650-X.

22. The premixes of claim 11 wherein said polyol is PLURACOL® 824.

23. The premixes of claim 12 wherein said polyol is NIAX® LA-700.

24. The premixes of claim 12 wherein aid polyol is VORANOL® 800.

25. The premixes of claim 13 wherein said polyol is TERATE® 203.

26. The premixes of claim 13 wherein said polyol is STEPANPOL® PS-2502-A.

27. The premixes of claim 16 wherein said triol is SF-265.

28. The premixes of claim 6 wherein said polyol is POLY-G® 75-442.

29. The premixes of claim 7 wherein said diol is PHT4-DIOL.

30. The premixes of claim 4 wherein said polyol is THANOL® 650-X.

31. Mixtures consisting essentially of a polyol or polyol blend suitable for polyurethane or polyisocyanurate foam preparation and 1,1,1,3,3-pentafluoropropane, catalyst, surfactant and, optionally, flame retardant, in proportions suitable for polyurethane or polyisocyanurate foam preparation.

32. Mixtures according to claim 31 consisting essentially of about 1 to about 60 weight per 100 parts by weight polyol of 1,1,1,3, 3-pentafluoropropane.

33. Mixtures according to claim 31 wherein said polyol or polyol blend is selected from the group consisting of polyether polyols, polyester polyols, methyl glucoside-based polyols, reactive brominated diol polyols, and blends thereof.

34. Mixtures according to claim 31 wherein said polyol is a polyether polyol.

35. Mixtures according to claim 31 wherein said polyol is a polyester polyol.

36. Mixtures according to claim 31 wherein said polyol is a methyl glucoside-based polyol.

37. Mixtures according to claim 31 wherein said polyol is a reactive brominated diol.

38. Mixtures according to claim 34 wherein said polyether polyol is a sucros based polyether polyol.

39. Mixtures according to claim 3 wherein said polyether polyol is a sucrose amine-based polyether polyol.

40. Mixture according to claim 34 wherein polyether polyol is an aromatic amine-polyether polyol.

41. Mixtures according to claim 34 wherein said polyether polyol is an aromatic initiator-based polyether polyol.

42. Mixtures according to claim 34 wherein said polyether polyol is an amine-based polyether polyol.

43. Mixtures according to claim 35 wherein said polyester polyol is an aromatic-based polyester polyol.

44. Mixtures according to claim 34 wherein said polyether polyol is an amine-based triol.
